(19) United States
(12) Patent Application Publication
(10) Pub. No.: US 2006/0237311 A1
(43) Pub. Date: Oct. 26, 2006

(54) IMMERSION MEASURING PROBE

(75) Inventor: Erik Gerits, Genk (BE)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: Heraeus Electro-Nite International N.V., Houthalen (BE)

(21) Appl. No.: 11/380,107

(22) Filed: Apr. 25, 2006

(30) Foreign Application Priority Data
Apr. 26, 2005 (DE) 10 2005 019 666.7

(51) Int. Cl. G01N 27/26

(52) U.S. Cl. 204/400

(57) ABSTRACT

An immersion measuring probe, particularly a drop-in measuring probe for molten metal, is provided having a measuring head, on which at least one sensor carrier having at least one sensor is arranged. The sensor carrier is held at or in an opening in the measuring head. At or near the opening in the measuring head, a combustible and/or a gas-containing or gas-generating porous material is arranged.

### BACKGROUND OF THE INVENTION

The invention relates to an immersion measuring probe, particularly a drop-in measuring probe for metal melts. The probe has a measuring head on which at least one sensor carrier having at least one sensor is arranged, wherein the sensor carrier is held at or in an opening of the measuring head.

Such measuring probes are known, for example, from German Patent DE 198 49 433 C1. Drop-in measuring probes are thrown from a certain height from a holder into a molten metal. The measuring head mounted at one end of a carrier tube is generally made of steel, in order to provide the mass required to penetrate the slag layer built up on molten steel or iron. Inside the carrier tube a signal cable is wound up, which is connected with a measurement system and which unwinds from the carrier tube during the fall into the molten metal. In the measuring head a sensor carrier having at least one sensor is arranged, for example a temperature sensor or an electrochemical element for measurement of the oxygen content of the molten metal. When penetrating the slag layer lying on top of molten steel, slag may adhere to the measuring head. This slag adhering to the measuring head, and perhaps to the protective cap for the sensors, can influence the measurement of the properties of the molten steel and lead to measurement errors.

### BRIEF SUMMARY OF THE INVENTION

The invention is based on the object of providing an improved immersion measuring probe with respect to measurement accuracy and reliability.

The object is achieved by an immersion measuring probe, particularly a drop-in measuring probe for molten metal, having a measuring head, on which at least one sensor carrier having at least one sensor is arranged, wherein the sensor carrier is held at or in an opening in the measuring head, and is characterized by a combustible and/or gas-containing or gas-generating porous material being arranged at or near the opening of the measuring head.

With the combustible porous material and/or a gas-containing or gas-generating material arranged at or near the opening of the measuring head, and during the immersion of the measuring head into the molten metal or into slag, due to the resulting heating of the measuring head, gas is released in the immediate vicinity of the sensor carrier, so that the adhesion of the slag is prevented or already adhered slag is removed by the explosive release of the gas. The released gas emerges from the pores of the porous material and is released by the volume expansion during heating or, for example, it is arises as a combustion gas during combustion or by vaporization of moisture from the corresponding material in the measuring head. For this purpose, it is necessary for the gas-releasing material during heating of the measuring head to temperatures up to more than 1,000° C. (for example by combustion, vaporization, or from gas-containing pores) to be arranged as close as possible to the sensor.

In particular, the porous material can be open-pored. The combustible material can appropriately be made of an organic material; in particular, it can contain a fibrous material or an organic binder. At or near the opening of the measuring head in which the sensor carrier is mounted, there can be an adhesive-containing body, particularly casting sand. The combustible or gas-containing material can also be a part of the sensor carrier or can be the material of the sensor carrier itself. For example, the sensor carrier can be made of casting sand. A ring-shaped or partially ring-shaped arrangement of the combustible or gas-containing material around the sensor carrier is also conceivable. The sensor carrier can preferably be connected with the measuring head in a locking manner in order to simplify mounting.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1A is a broken-away, top perspective view of one embodiment of a measuring head of the invention;

FIG. 1B is a top plan view of the measuring head of FIG. 1A;

FIG. 2A is a broken-away, top perspective view of another embodiment of a measuring head of the invention; and

FIG. 2B is a top plan view of the measuring head of FIG. 2A.

### DETAILED DESCRIPTION OF THE INVENTION

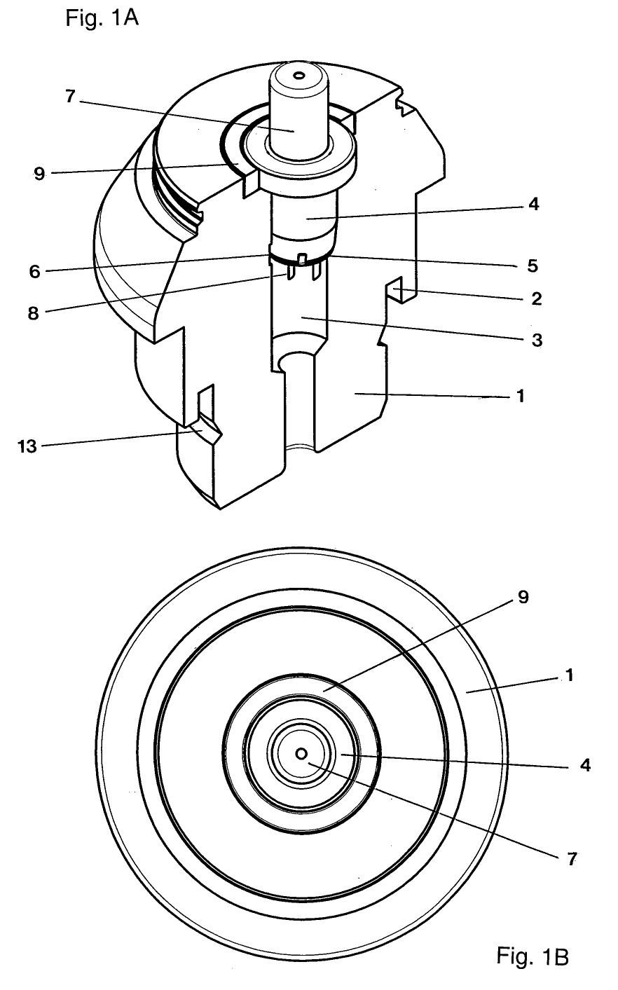

FIGS. 1A and 1B show measuring head 1 of a drop-in measuring probe. Measuring head 1 is usually mounted on the end of a carrier tube, which can be made of cardboard. Ring groove 2 or ring groove 13 of measuring head 1 can be used for this purpose. The carrier tube is not shown in the drawings for reasons of clarity.

Measuring head 1 is made of steel. It has a central longitudinal bore 3. In the immersion end of measuring head 1 a sensor carrier 4 is mounted in bore 3. Sensor carrier 4 has, on its rear end facing away from the immersion end, one or more hooks 5, which engage in a groove 6 when the sensor carrier 4 is inserted into bore 3, and which fix sensor carrier 4 in bore 3. Sensor head 4 has one or more sensors under a protective cap 7, for example a thermo-element and/or an electrochemical sensor for determination of the gas content of the molten steel for whose analysis the immersion measuring probe is used. The sensor is connected via contacts 8 on the rear end of sensor carrier 4 to signal lines, which are connected through the bore to a measurement unit or a computer. On the immersion end of measuring head 1, a ring 9 of casting sand is arranged around sensor carrier 4.

While penetrating the slag layer lying on top of the molten steel or upon immersion in the molten steel, the measuring head is quickly heated to the temperature of the molten steel. The gas present in the pores of the casting sand thereby experiences a rapid increase in volume, so that it emerges very quickly from ring 9, and thereby actually rips away any slag adhering to sensor carrier 4 or protective cap 7. Consequently, the slag does not influence the immediate vicinity of the sensor, so that the measurement accuracy is increased.

Protective cap 7 can be made of metal or of cardboard. Sensor carrier 4 can also be made of steel. Ring 9 can even be made of cardboard, for example, instead of casting sand. The measuring head can in principle also be used without a carrier tube.

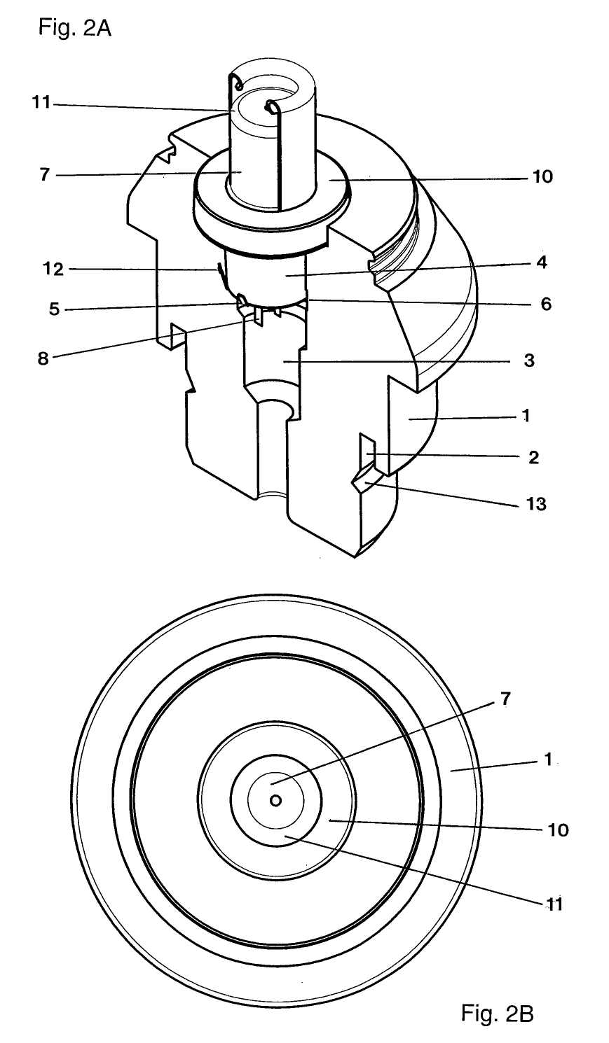

FIGS. 2A and 2B show a similar measuring head 1. The sensor carrier 4 arranged in bore 3 of the measuring head 1 has a ring 10 made of casting sand. It is also possible to make the entire sensor carrier 4 of casting sand. At least ring 10 can also be made of cardboard or a similarly combustible or gas-containing porous material. The sensor of sensor carrier 4 is covered with a protective cap 7, which in turn is covered with a cardboard cap 11. Both cardboard cap 11 and the protective cap 7 are destroyed upon entering into the molten steel, so that the sensor comes into contact with the molten steel. A standard electrochemical element arranged on sensor carrier 4 needs a so-called bath contact for its functioning. This bath contact is expediently produced by the corresponding contact of the electrochemical element leading from the underside of sensor carrier 4 being directly connected electrically to the metallic measuring head 1 via a contact tab 12 or a different electrical, preferably metallic, conductor, so that the body of the of the measuring head 1 itself makes electrical contact with the molten metal.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. An immersion measuring probe for molten metal, the probe comprising a measuring head, on which at least one sensor carrier having at least one sensor is arranged, the sensor carrier being held at or in an opening in the measuring head, and at least one material selected from a combustible material, a gas-containing porous material and a gas-generating porous material being arranged at or near the opening of the measuring head.

2. The immersion measuring probe according to claim 1, wherein the porous materials are open-pored.

3. The immersion measuring probe according to claim 1, wherein the combustible material is an organic material.

4. The immersion measuring probe according to claim 3, wherein the organic material comprises a fibrous material or an organic binder.

5. The immersion measuring probe according to claim 1, wherein a binder-containing body is arranged at or near the opening.

6. The immersion measuring probe according to claim 5, wherein the binder-containing body comprises casting sand.

7. The immersion measuring probe according to claim 1, wherein the at least one material forms at least a part of the sensor carrier.

8. The immersion measuring probe according to claim 1, wherein the sensor carrier is connected in a locking manner with the measuring head.

9. The immersion measuring probe according to claim 1, wherein the probe is a drop-in measuring probe.
